(19) United States
(12) Patent Application Publication
(10) Pub. No.: US 2014/0371918 A1
(43) Pub. Date: Dec. 18, 2014

(54) CONTROLLER FOR A HVAC SYSTEM HAVING A CALIBRATION ALGORITHM

(71) Applicant: Lennox Industries Inc., Richardson, TX (US)

(72) Inventors: Jonathan Douglas, Richardson, TX (US); Alan Bennett, Richardson, TX (US); Farhad Abrishamkar, Richardson, TX (US); Paul Foden, Richardson, TX (US); Stephen Walter, Richardson, TX (US); Herman M. Thomas, Richardson, TX (US); Krishna Doddamane, Allen, TX (US)

(21) Appl. No.: 13/919,649

(22) Filed: Jun. 17, 2013

(51) Int. Cl. F24F 11/00; G05D 7/06

(52) U.S. Cl. CPC F24F 11/0009; G05D 7/06
USPC 700/276

(57) ABSTRACT

This disclosure presents a controller for use with a HVAC system that has a program stored therein that is configured to relate a torque of a fan motor of a HVAC system with an airflow rate of the HVAC system, such that a selected airflow rate will cause the fan motor to operate at a torque that will produced the selected airflow rate.

### TECHNICAL FIELD

This application is directed, in general, to heating, ventilating and air conditioning (HVAC) systems, and to a controller, among other things, having a calibration algorithm that relates a fan motor command to an airflow of a HVAC system.

### BACKGROUND

(HVAC) systems can be used to regulate the environment within an enclosed space. Typically, an air blower is used to pull air (i.e., return air) from the enclosed space into the HVAC system through ducts and push the air (i.e., return air) back into the enclosed space through additional ducts after conditioning the air (e.g., heating, cooling or dehumidifying the air). Various types of HVAC systems may be used to provide conditioned air for enclosed spaces. For example, some HVAC units are located on the rooftop of a commercial building. These so-called rooftop units, or RTUs, typically include one or more blowers and heat exchangers to heat and/or cool the building, and baffles to control the flow of air within the RTU. Some RTUs also include an air-side economizer that allows selectively providing fresh outside air (i.e., ventilation or ventilating air) to the RTU or to recirculate exhaust air from the building back through the RTU to be cooled or heated again. After installation, industry standards provide a technician to manually set the airflow rate for the installed unit.

### SUMMARY

In one embodiment, a controller for an HVAC system is disclosed. The controller comprises a control board, a microprocessor located on and electrically coupled to the control board, and a memory coupled to the microprocessor and located on and electrically coupled to the control board. The memory has a program stored thereon that is configured to relate an operational fan motor command of a HVAC system with an airflow rate of the HVAC system, such that a selected airflow rate will cause a fan motor of the HVAC system to operate based on the operational fan motor command to produce the selected airflow rate.

In another embodiment, there is provided a HVAC system. This embodiment comprises a housing having openings for exhaust air, ventilation air, return air and supply air. The housing further has an exhaust fan, an economizer, a heat exchanger, an indoor fan, a heating element and a primary HVAC controller located within the housing. A secondary controller is configured to relate an operational fan motor command of a HVAC system with an airflow rate of the HVAC system, such that a selected airflow rate will cause a fan motor of the HVAC system to operate based on the operational fan motor command to produce the selected airflow rate.

In another aspect, a computer program product, including a non-transitory computer usable medium having a computer readable program code embodied therein, the computer readable program code is adapted to be executed to implement a method of measuring and managing ventilation airflow of an HVAC system having an economizer with an outdoor damper. In one embodiment the method comprises relating an operational fan motor command of a HVAC system with an airflow rate of the HVAC system, such that a selected airflow rate will cause a fan motor of the HVAC system to operate based on the operational fan motor command to produce the selected airflow rate, and building a calibration table during initial operation of an installed HVAC system that relates a given operational fan motor command to a given airflow rate.

### BRIEF DESCRIPTION OF THE DRAWINGS

Reference is now made to the following descriptions taken in conjunction with the accompanying drawings, in which:

FIG. 1 is a graph that relates supply airflow to torque as % pulse width modulation (PWM) and static pressure rise in a poor duct system versus a good duct system;

FIG. 2 is a graph that relates supply airflow to motor speed in rounds per minute (rpm) and static pressure rise in a poor duct system versus a good duct system;

FIG. 3 illustrates a flow diagram of an embodiment of a method of calibrating a unit based on a relationship between an operational fan motor command and airflow rate;

FIG. 4 illustrates a block diagram of an embodiment of ventilation having an economizer associated therewith, and in which the embodiments of the controller, has provided therein, may be employed; and

FIG. 5 illustrates a block diagram of the control board of the controller, as provided herein.

### DETAILED DESCRIPTION

Proper calibration is important to run a HVAC system, such as a commercial roof top unit, optimally. However, calibration is currently conducted manually, which takes time and often does not lead to an optimized HVAC system once the HVAC system has been manually calibrated.

One aspect of this disclosure provides an operations command program implemented on a controller for determining the airflow rate of a HVAC system based on an operational fan motor command of a HVAC system, such that a selected airflow rate will cause the fan motor to operate at an operational command that will produce the desired airflow rate to optimize the HVAC system. This is in contrast to industry standards that require manual calibration, which can lead to less than an optimized HVAC system. The relationship between airflow rate and an operation fan motor command is achieved by the controller running a calibration procedure and collecting operational data from the HVAC system once it has been applied in the field and powered-up, and the appropriate filters are installed. In one embodiment, the program may be initiated by the field technician, or in another embodiment, the controller may automatically initiate the routine, if a predetermined amount of time has passed from the point of installation and power up of the HVAC system. As used herein and in the claims, an operational fan motor command involves two types of motor commands. One is based on torque that may range from 20% to 100%, depending on the motor's configuration. The other is motor speed based on rpm. The motor speed may be based on direct speed control where 100% is equal to the maximum motor speed, for example in one motor configuration, 100% speed may be 1600 rpm. Alternatively, the motor speed may be based on motor frequency. In such instances, the frequency output of a variable frequency drive (VFD) is set, where 100% is equal to 60 Hz for United States applications or 100% is equal to 50 Hz for European applications. The following Table 1 illustrates one embodiment of a calibration table that may be present in controller memory that relates the motor command function to both torque and motor speed:

TABLE 1

| Motor Command | Torque % Max. | Speed RPM | Speed Hz |
|---|---|---|---|
| 20 | 20 | 320 | 12 |
| 40 | 40 | 620 | 24 |
| 60 | 60 | 960 | 36 |
| 80 | 80 | 1280 | 48 |
| 100 | 100 | 1600 | 60 |

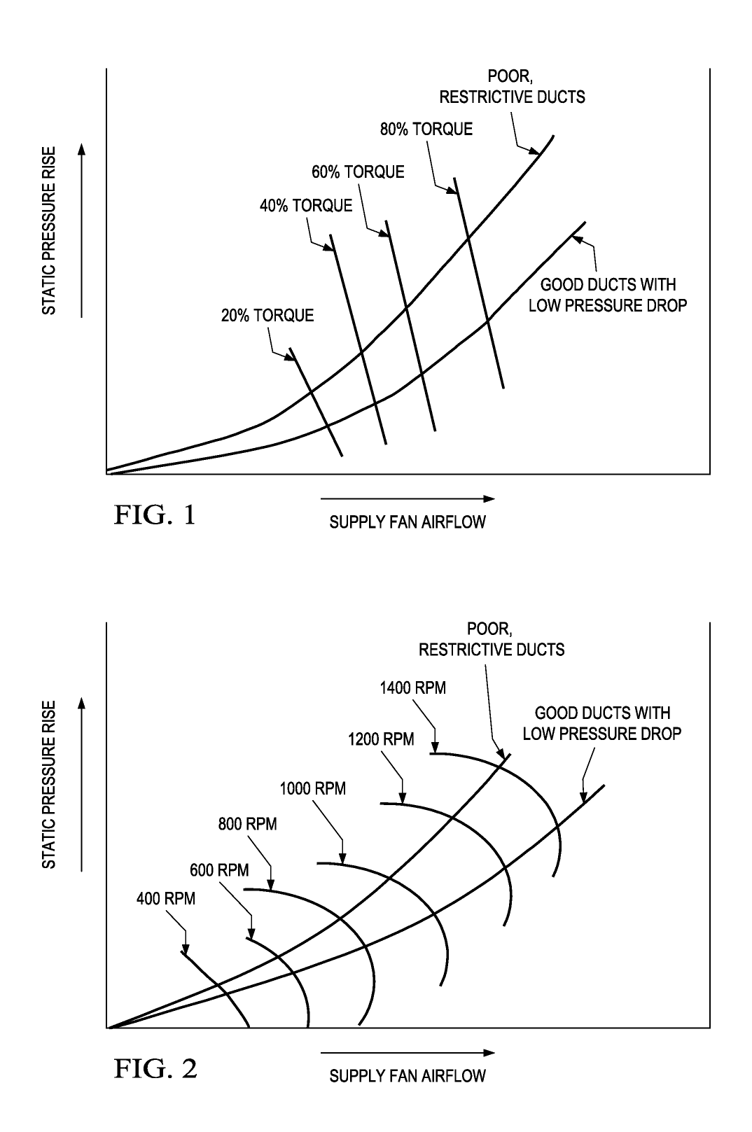

FIG. 1 is a generalized graph illustrating the relationship between Torque, as determined by % pulse width modulation (PWM), and supply airflow in cubic feet/minute (CFM), as might be present in one motor/HVAC system configuration. The graph illustrates a first calibration curve in a poor restrictive duct having a higher pressure drop and a second calibration curve of a good duct system that has a low pressure drop. As seen, as the torque and static pressure increase, the airflow rate increases in a non-linear fashion in both types of duct systems. Thus, in this embodiment a calibration table can be built within a controller and be used to select a desired airflow rate, which would cause the motor to run at a torque that is necessary for producing the selected airflow. As noted from FIG. 1, the duct configuration has an effect on the torque that is required to achieve the desired airflow.

The following Table 2 provides an embodiment of different values that might be measured by the calibration process and stored into the controller where the motor command is based on torque.

TABLE 2

| Torque (% PWM) | Airflow Good Duct | Airflow Poor Duct |
|---|---|---|
| 20 | 1050 | 975 |
| 40 | 1450 | 1350 |
| 60 | 1850 | 1725 |
| 80 | 2150 | 2025 |
| 100 | 2400 | 2250 |

FIG. 2 is a generalized graph illustrating the relationship between motor speed, as determined by rpms, and supply airflow in cubic feet/minute (CFM), as might be present in one motor/HVAC system configuration. The graph illustrates a first calibration curve in a poor restrictive duct having a higher pressure drop and a second calibration curve of a good duct system that has a low pressure drop. As seen, as the motor speed (rpm) and static pressure increase, the airflow rate increases in a non-linear fashion in both types of duct systems. Thus, in this embodiment a calibration table can be built within a controller and be used to select a desired airflow rate, which would cause the motor to run at a speed that is necessary for producing the selected airflow. As noted from FIG. 2, the duct configuration has an effect on the motor speed that is required to achieve the desired airflow.

The following Table 2 provides an embodiment of different values that might be measured by the calibration process and stored into the controller where the motor command is based on motor speed.

TABLE 3

| Motor Speed RPM | Airflow Good Duct | Airflow Poor Duct |
|---|---|---|
| 400 | 775 | 700 |
| 600 | 1350 | 1200 |
| 800 | 1700 | 1425 |
| 1000 | 2100 | 1775 |
| 1200 | 2600 | 2150 |
| 1400 | — | 1550 |

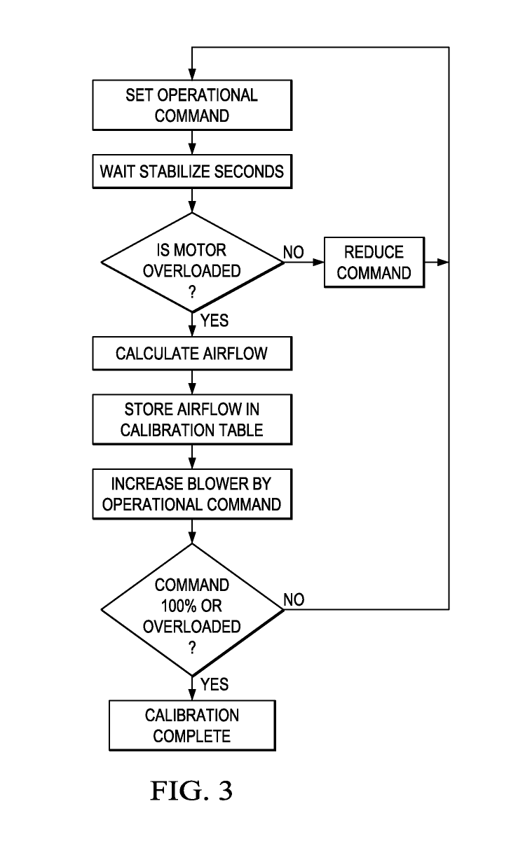

In one embodiment of a calibration process flow illustrated in FIG. 3, the calibration procedure starts by setting operational fan motor command to the appropriate setting. For example, in the embodiment where the operational fan motor command is based torque, the initial setting might be 20% PWM. Alternatively, where the operational fan motor command is based on speed, the initial setting might be 320 rpm. Once the fan has stabilized and is running at the correct rpm or torque, the corresponding airflow rate is calculated and stored in a table. As noted above, the corresponding airflow rate will depend on the type of duct system that is associated with the HVAC system. The operation command is then incremented and allowed to stabilize. The airflow rate is then recorded in the table. This process is repeated until the operational command reaches 100% of either the torque or motor speed. Three parameters may require adjustment during product development, which are stabilize seconds, operational command increment, and cutback.

Stabilize seconds is the amount of time the controller should wait after a change in the operational command demand before making an airflow measurement. The number may likely be in the range of 30 seconds, though it could be as low as 15 second and as high as 90 seconds.

Operational increment is the amount that either the torque or motor speed changed during each subsequent step in the calibration process. A smaller increment will provide better accuracy as it will generate more records in the calibration, but will require more time for calibration. In one embodiment, this value may be 20. However, in other embodiments, it could be as small as 5 and as large as 40.

Motor overload is the motor power output at which the motor will sustain damage if operated at this level for a prolonged period of time. When the blower command is torque, motor overload is indicated when the motor speed exceeds a predefined limit. When the blower command is speed, motor overload is indicated when the motor power exceeds a predefined limit.

In one embodiment, the calibration process will result in TABLE 4. It should be noted that the number of rows in the table is a function of the operational command increment. TABLE 4 was developed with a torque increment of 10%.

TABLE 4

| | Speed | Supply Airflow |
|---|---|---|
| Row | (RPM) | (CFM) |
| 1 | 20 | 400 |
| 2 | 30 | 450 |
| 3 | 40 | 500 |
| 4 | 50 | 550 |
| 5 | 60 | 600 |
| 6 | 70 | 950 |
| 7 | 80 | 1200 |
| 8 | 90 | 1300 |
| 9 | 100 | 1300 |

When using speed as the motor command, the calibration process will result in TABLE 5. It should be noted that the number of rows in the table is a function of the operational command increment. TABLE 5 was developed with a speed increment of 100 RPM.

TABLE 5

| | Speed | Supply Airflow |
|---|---|---|
| Row | (RPM) | (CFM) |
| 1 | 500 | 400 |
| 2 | 600 | 450 |
| 3 | 700 | 500 |
| 4 | 800 | 550 |
| 5 | 900 | 600 |
| 6 | 1000 | 950 |
| 7 | 1100 | 1200 |
| 8 | 1200 | 1300 |
| 9 | 1300 | 1300 |

In some applications with excessive duct resistance, the blower motor will reach its overload limit speed before the calibration procedure reaches the maximum blower command of 100%. In such cases, the calibration procedure will find the highest command (e.g., with 2.5%) at which the blower can operate without exceeding the cutback speed, which result in calibration TABLE 6, as follows:

TABLE 6

| | Torque | Supply Airflow |
|---|---|---|
| Row | (% PWM) | (CFM) |
| 1 | 20 | 400 |
| 2 | 30 | 450 |
| 3 | 40 | 500 |
| 4 | 50 | 550 |
| 5 | 60 | 600 |
| 6 | 70 | 950 |
| 7 | 80 | 1200 |
| 8 | 87.5 | 1280 |

As noted above, the calibration procedure, as discussed herein, may be initiated either by a technician or automatically. For example, in one embodiment, the calibration procedure may automatically initiate the calibration procedure hours after initial power up, if it has not yet been initiated manually by the technician. This period of time may vary from one embodiment to another. The delay is selected to give the technician sufficient time to ensure the unit is correctly installed and manually initiate the calibration at their convenience. However, if the technician fails to calibrate the controller, it will do so within the prescribed time frame.

At any time, the technician may enter the desired airflow rate corresponding to each mode of operation. The following TABLE 7 is an example list of operating modes and their corresponding desired airflow rate. The airflow rate may also be entered via network communications with the controller.

TABLE 7

| Mode | Desired Airflow |
|---|---|
| Cool High | 1950 |
| Cool Low | 1200 |
| Cool Med. High | 1800 |
| Cool Med. Low | 1500 |
| Heat | 1900 |
| Ventilation | 1300 |
| Smoke | 2000 |

Once the blower has been calibrated, the operational command required to deliver each of the desired airflows may be calculated by linearly interpolating the data in the calibration table. For example, to determine the torque or motor speed necessary to deliver 1150 CFM, the controller searches the TABLE 4 for the row with an airflow rate that is above and below the desired (des) airflow rate. For example, in TABLE 5, the airflow rate in row 6 is 950, which is the first row below the target of 1150. The airflow in row 7 is 1200, which is the first row above the target. The controller would then use the following equation to calculate the desired (des) operational motor command (MotorCmd) required to produce the desired airflow rate:

MotorCmd_des=MotorCmd_lo+(CFM_des−FM_lo)*(MotorCmd_hi−MotorCmd_Lo)/(CFM_hi−CFM_lo).

Appling the values from Table 2 to the equation:

78(MotorCmd_des)=70(MotorCmd_lo)+(1150(CFM_des)−950(CFM_lo))*(80(MotorCmd_hi)−70(MotoCmd_lo))/(1200(CFM_hi)−950(CFM_lo)).

If the desired airflow is greater than the airflow corresponding to 100% operational motor command, the blower is insufficient to deliver the desired airflow. Typically, this indicates excessive duct pressure drops or an unrealistically high airflow rate. In such instances, a flag error will be produced, and the airflow rate will be adjusted such that it corresponds to 100% operational motor command. On the other hand, if the desired airflow is less than the airflow corresponding to the minimum operational motor command, the blower motor is unable to run slow enough to meet the desired airflow rate (typically the airflow entered is unrealistically low). In such cases, a flag error will be produced and the airflow rate is set to correspond to the minimum operational motor command. The following Table 8 is an example, in one embodiment, of what might be produced in such circumstances.

TABLE 7

| | | Motor Command | |
|---|---|---|---|
| | | Torque | |
| Mode | Desired Airflow | (PWM %) | Speed (RPM) |
| Cool High | 1950 | 94 | 1200 |
| Cool Low | 1200 | 56 | 738 |
| Cool Med. High | 1800 | 91 | 1108 |
| Cool Med. Low | 1500 | 75 | 923 |
| Heat | 1900 | 93 | 1169 |
| Ventilation | 1300 | 64 | 800 |
| Smoke | 2000 | 95 | 1231 |

During normal operation of the unit, the controller commands the motor to run the motor command associated with each operating mode. For example, in one embodiment, when in Cool Low mode, the motor will be commanded to run at 56% torque. Assuming nothing changes in the unit and duct system, the unit should then run at 1200 CFM.

The date stored in the calibration table may also be used for airflow diagnostics. As mentioned earlier, the relationship between the operational fan motor command and airflow rate is a function of the unit performance and the duct system pressure drop. After calibration, it is likely that the duct system pressure drop will increase due to fouling of air filters. As the pressure drop increases, the airflow rate associated with a given torque setting will decrease.

In certain embodiments, the controller can be programmed (i.e., configured) to continuously measure the airflow rate. The current measured airflow rate is then compared with the airflow stored in the calibration table. If the currently measured airflow rate is significantly higher or lower than the calibrated value, the controller, in some embodiments, is configured to send an alarm signal. A current airflow that is lower than the calibrated value can indicate increased duct pressure drop or a dirty filter. A current airflow that is higher than the calibrated value can indicate reduced pressure drop, which may result when a unit door is opened, a duct is broken, or a filter type is changed. For example, when in cool low mode, the controller commands the motor to run at 56% PWM (torque). The airflow measurement reports that the current airflow, when at 56% torque, is 1000 CFM. The controller compares this with the originally calibrated value of 1200 CFM, which is 16.6% lower than the calibrated airflow. In such instances, the controller sends an alarm signal when the airflow is 15% or lower.

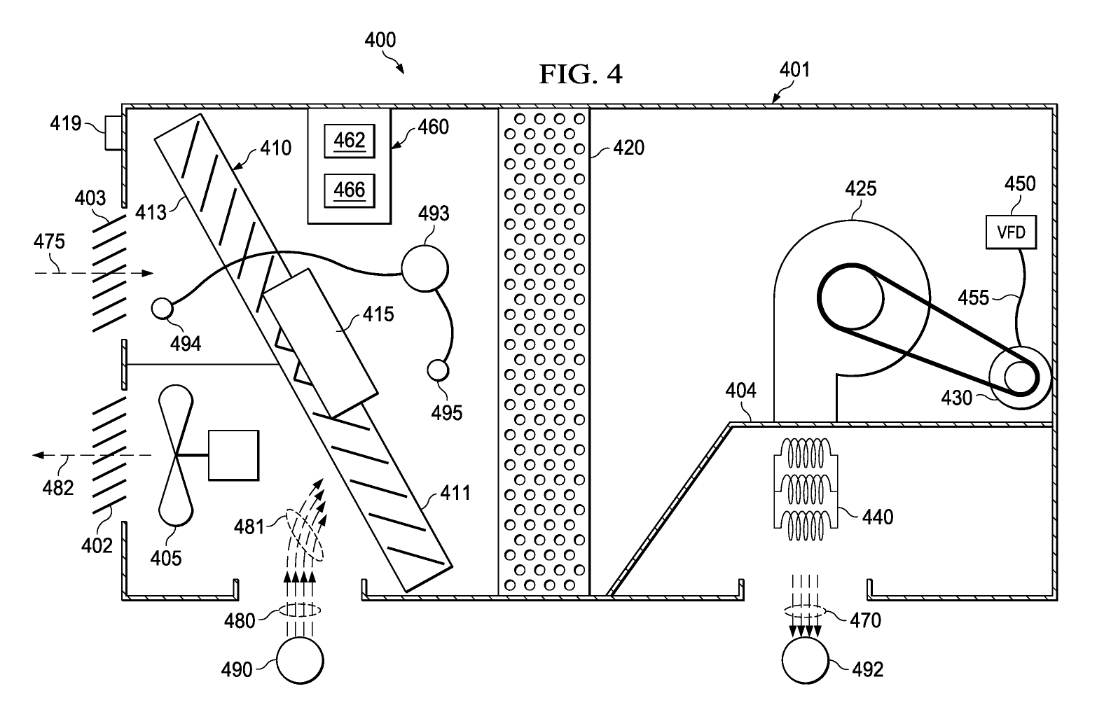

FIG. 4 illustrates a block diagram of an embodiment of an HVAC system 400 in which the controller as discussed herein may be employed. The system 400 includes an enclosure 401 (e.g., a housing) with openings for exhaust air, ventilation air, return air and supply air. The housing 401 includes exhaust vents 402 and ventilation vents 403 at the corresponding exhaust air and ventilation air openings. Within the housing 401, the system 400 includes an exhaust fan 405, economizer 410, a heat exchanger 420, an indoor fan 425 driven by a fan motor 430 and a heating element 440. Additionally, the system 400 includes a conventional motor controller 450, and a HVAC controller 460, which can be configured in accordance with the embodiments described herein. The motor controller 450 may be coupled to the blower motor 430 via a conventional cable 455, or it may be attached directly to the motor 430. The controller 460 is connected to the motor 430 either wirelessly or connected by hardwire and both the motor controller 450 and the controller 460 are configured to communicate data therebetween. The controller 460 may be further connected to various components of the system 400, including a thermostat 419 for determining outside air temperature, via wireless or hardwired connections for communicating data. Conventional cabling or wireless communications systems may be employed. Also included within the enclosure 401 is a partition 404 that supports the blower 425 and the motor 430 and provides a separate heating section.

In the illustrated embodiment, the HVAC system 400 is a RTU. One skilled in the art will understand that the system 400 can include other partitions or components that are typically included within an HVAC system, such as a RTU. While the embodiment of the system 400 is discussed in the context of a RTU, the scope of the disclosure includes other HVAC applications that are not roof-top mounted.

The blower 425 and motor 430 operate to force an air stream 470 into a structure, such as a building, being conditioned via an unreferenced supply duct. A return airstream 480 from the building enters the system 400 at an unreferenced return duct.

A first portion 481 of the air stream 480 re-circulates through the economizer 410 and joins the air stream 470 to provide supply air to the building. A second portion of the air stream 480 is air stream 482 that is removed from the system 400 via the exhaust fan 405.

The economizer 410 operates to vent a portion of the return air 480 and replace the vented portion with the air stream 475. Thus, air quality characteristics such as CO₂ concentration and humidity may be maintained within defined limits within the building being conditioned. The economizer 410 includes an indoor damper 411, an outdoor damper 413 and an actuator 415 that drives (opens and closes) the indoor and outdoor dampers 411, 413 (i.e., the blades of the indoor and outdoor dampers 411, 413). Though the economizer 410 includes two damper assemblies, one skilled in the art will understand that the concepts of the disclosure also apply to those economizers or devices having just a single damper assembly, an outdoor damper assembly.

In certain embodiments, the controller 460 includes an interface 462 and a ventilation director 466. The ventilation director 466 may be implemented on a processor and/or a memory of the controller 460. The interface 462 receives feedback data from sensors and components of the system 400 and transmits control signals thereto. As such, the controller 460 may receive feedback data from, for example, the exhaust fan 405, the fan 425 or the fan motor 430 and/or the fan controller 450, the economizer 410 and the thermostat 419, and transmit control signals thereto, if applicable. One skilled in the art will understand that the location of the controller 460 can vary with respect to the HVAC system 400.

The interface 462 may be a conventional interface that employs a known protocol for communicating (i.e., transmitting and receiving) data. The interface 462 may be configured to receive both analog and digital data. The data may be received over wired, wireless or both types of communication mediums or through a universal serial bus (USB) port. In some embodiments, a communications bus may be employed to couple at least some of the various operating units to the interface 462. Though not illustrated, the interface 462 includes input terminals for receiving feedback data in the form of a calibration report, and to which an external computer or a storage device may be coupled for the transfer a calibration report data. In certain embodiments, the controller 460 may be configured to provide the calibration report in a concise and easy to read pre-formatted report form.

The feedback data received by the interface 462 may include data that corresponds to a pressure drop across the outdoor damper 413 and damper position of the economizer 410. In some embodiments, the feedback data also includes the supply airflow rate. Various sensors of the system 400 are used to provide this feedback data to the HVAC controller 460 via the interface 462. In some embodiments, a return pressure sensor 490 is positioned in the return air opening to provide a return static pressure. The return pressure sensor 490 measures the static pressure difference between the return duct and air outside of the HVAC system 400. In one embodiment, a supply pressure sensor 492 is also provided in the supply air opening to indicate a supply pressure to the HVAC controller 460. The supply pressure sensor 492 measures the static pressure difference between the return duct and the supply duct. Pressure sensor 493 is used to provide the pressure drop across outdoor damper 413 of the economizer 410. The pressure sensor 493 is a conventional pressure transducer that determines the static pressure difference across the outdoor damper 413. The pressure sensor 493 includes a first input 494 and a second input 495 for receiving the pressure on each side of the outdoor damper 413. The pressure sensors discussed herein can be conventional pressure sensors typically used in HVAC systems.

The HVAC controller 460 is configured to determine an airflow rate based on a torque of the motor 430.

Economizer damper position is provided to the HVAC controller 460 via the actuator 415. The actuator 415 is configured to rotate or move the indoor and outdoor dampers 411, 413, of the economizer 410 in response to a received signal, such as control signals from the HVAC controller 460 (i.e., the ventilation director 466). The actuator 415 is a conventional actuator, such as an electrical-mechanical device, that provides a signal that corresponds to the economizer damper position (i.e., blade angle of the outdoor damper 413 of the economizer 410). The signal is an electrical signal that is received by the ventilation director 466 which is configured to determine the relative angle of the outdoor damper 413 based on the signal from the actuator 415. A lookup table or chart may be used by a processor associated with the ventilation director 466 to determine a relative blade angle with respect to an electrical signal received from the actuator 415. The angle can be based on (i.e., relative to) the ventilation opening of the HVAC system 400. In some embodiments, the economizer damper position can be determined via other means. For example, an accelerometer coupled to a blade (or multiple accelerometers to multiple blades) of the outdoor damper 413 may be used to determine the economizer damper position. The outdoor damper 413 is opened at 100 percent when the blades thereof are positioned to provide maximum airflow of ventilation air 475 into the system 400 through the ventilation opening. In FIG. 4, the blades of the outdoor damper 413 would be perpendicular to the ventilation opening or the frame surrounding the ventilation opening when opened at 400 percent. In the illustrated embodiment, the blades of the outdoor damper 413 would be parallel to the ventilation opening when opened at zero percent.

The ventilation director 466 is configured to determine an operating ventilation airflow rate of the HVAC system based on the static pressure difference across the outdoor dampers 413, the economizer damper position and economizer ventilation data. In some embodiments, the ventilation director 466 also employs the supply airflow rate to calculate the operating ventilation airflow rate. In one embodiment, using the supply airflow rate for the calculation is based on the economizer damper position being above 50 percent. In one embodiment, the economizer ventilation data is developed during manufacturing or engineering of the system 400 or similar type of HVAC systems. During development, a ventilation airflow rate is measured in, for example, a laboratory, at a variety of operating conditions. Various sensors and/or other type of measuring devices are employed during the development to obtain the measured data for the various operating conditions. Economizer ventilation data is developed from the measured data and can be loaded into the HVAC controller 460, such as a memory thereof. During operation in the field, the HVAC controller 460 (i.e., the ventilation director 466) receives the feedback data and can use this data in conjunction with the calibration table to adjust the airflow rate employing the feedback data and the economizer ventilation data.

The ventilation director 466 is further configured to adjust a position of the economizer 410 based on the economizer damper position and a desired ventilation airflow rate. The desired ventilation airflow rate can be determined as explained above by the controller 460. Also, the controller 460 may communicate with the ventilation director 466 to direct the actuator 415 to adjust a position of the blades of the economizer 410 based on the desired ventilation airflow rate as determined by the controller 460.

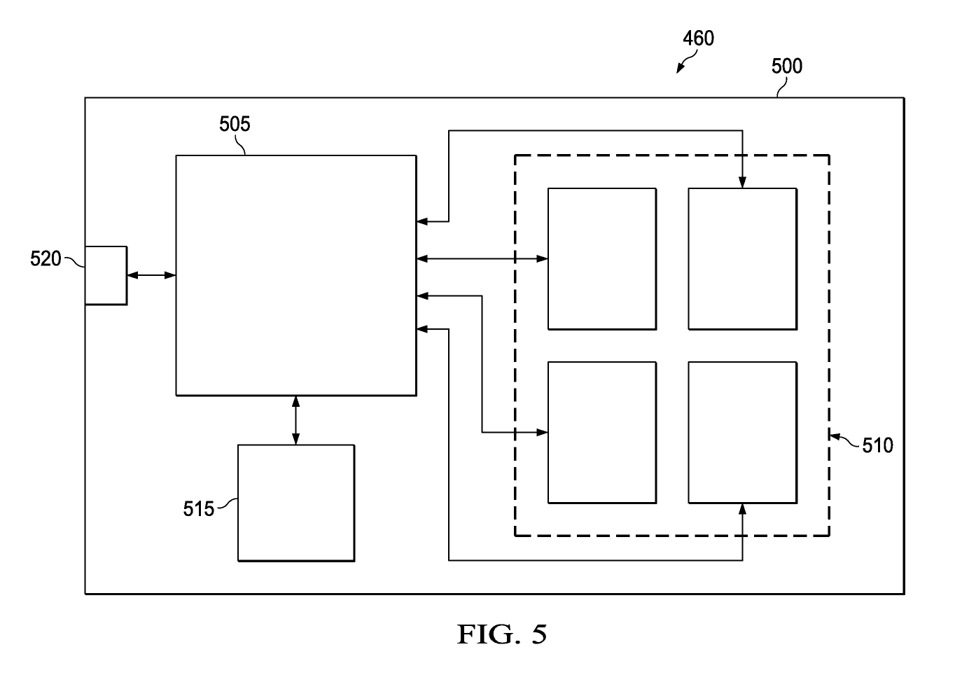

FIG. 5 illustrates a schematic view of one embodiment of the controller 460, as discussed with respect to FIG. 4. In this particular embodiment, the controller 460 includes a circuit wiring board 500 on which is located a microprocessor 505 that is electrically coupled to memory 510 and communication circuitry 515. The memory 510 may be a separate memory block on the circuit wiring board 500, as illustrated, or it may be contained within the microprocessor 505. The communication circuitry 515 is configured to allow the controller 560 to electronically communicate with other components of the HP system 500, either by a wireless connection or by a wired connection. The controller 560 may be a standalone component or it may be included within one of the other controllers previously discussed above. In one particular embodiment, the controller 460 will be included within the thermostat 519. In those embodiments where the controller 560 is a standalone unit, it will have the appropriate housing and user interface 520 components, such as a USB port, associated with it for the transfer of data, as described above.

The controller 460 is configured or programmed with an algorithm and data that relates builds a calibration during set up that relates a selected airflow rate with the selected operational fan motor command that will produced the desired airflow rate. In one embodiment, the program of the controller 460 is further configured to automatically build the calibration table within a predetermined time after an installation of said HVAC system, as mentioned above. In another aspect, the controller 460 is further configured to continuously measure a present airflow rate and compare the measured airflow rate with a stored airflow rate in calibration table and send an alarm signal when the present airflow rate is higher or lower than the stored airflow rate.

In yet another embodiment, the controller 460, as discussed above, may comprise a non-transitory computer usable medium having a computer readable program code embodied therein. The computer readable program code adapted to be executed to implement a method of measuring and managing an airflow rate of a heating, ventilating and air conditioning (HVAC) system by relating an operational fan motor command of the HVAC system with an airflow rate of the HVAC system, such that a selected airflow rate will cause said fan motor to operate at the operational fan motor command that will produced said selected airflow rate and building a calibration table during initial operation of an installed HVAC system, wherein the calibration table relates a given operational fan motor command to a given airflow rate.

Those skilled in the art to which this application relates will appreciate that other and further additions, deletions, substitutions and modifications may be made to the described embodiments.

What is claimed is:

1. A controller for a heating, ventilating and cooling (HVAC) system, comprising:
a control board;
a microprocessor located on and electrically coupled to said control board; and
a memory coupled to said microprocessor and located on and electrically coupled to said control board and having a program stored thereon, said program configured to relate an operational fan motor command of a HVAC system with an airflow rate of said HVAC system, such that a selected airflow rate will cause a fan motor of said HVAC system to operate based on said operational fan motor command to produce said selected airflow rate.

2. The controller recited in claim 1, wherein said program of said controller is further configured to build a calibration table during initial operation of an installed HVAC system, said calibration table relating a given operational fan motor command to a given airflow rate.

3. The controller recited in claim 2, wherein said program of said controller is further configured to automatically build said calibration table within a predetermined time after an installation of said HVAC system.

4. The controller recited in claim 2, wherein said operational fan motor command is calculated by said controller from said calibration table as follows:
OperationalCmd_des=OperationalCmdTorque_lo+(CFM_des−CFM_lo)*(OperationalCmd_hi−OperationalCmd_Lo)/(CFM_hi−CFM_lo)

5. The controller recited in claim 2, wherein said controller is further configured to continuously measure a present airflow rate and compare said measured airflow rate with a stored airflow rate in said calibration table.

6. The controller recited in claim 5, wherein said controller is further configured to send an alarm signal when said present airflow rate is higher or lower than said stored airflow rate.

7. The controller recited in claim 1, wherein said controller is coupled to a primary controller of said HVAC system, said primary controller is configured to control an operation of said HVAC system according to a temperature set-point.

8. The controller recited in claim 1, wherein said operational fan motor command is a rotational speed of said fan motor.

9. The controller recited in claim 1, further comprising communication circuitry capable of communicating with said fan motor or a primary controller of said HVAC system, or both.

10. The controller recited in claim 1, wherein said program is further configured to transmit calibration report data and said control board further comprises a data transfer port to which an external computer or a storage device may be coupled for transfer of said calibration report data.

11. A Heat Ventilation Air Conditioning (HVAC) system, comprising:
a housing having openings for exhaust air, ventilation air, return air and supply air, said housing further having an exhaust fan, an economizer, a heat exchanger, an indoor fan, a heating element and a primary HVAC controller located within said housing; and
a secondary controller configured to relate an operational fan motor command with an airflow rate of said HVAC system, such that a selected airflow rate will cause a fan motor of said HVAC system to operate based on said operational fan motor command to produce said selected airflow rate.

12. The HVAC system recited in claim 11, wherein said secondary controller is further configured to build a calibration table during initial operation of an installed HVAC system, said calibration table relating a given operational fan motor command to a given airflow rate.

13. The HVAC system recited in claim 12, wherein said operational fan motor command is calculated by said secondary controller from said calibration table as follows:
OperationalCmd_des=OperationalCmdTorque_lo+(CFM_des−CFM_lo)*(OperationalCmd_hi−OperationalCmd_Lo)/(CFM_hi−CFM_lo)

14. The HVAC system recited in claim 12, wherein said secondary controller is further configured to continuously measure a present airflow rate and compare said measured airflow rate with a stored airflow rate in said calibration table.

15. The HVAC system recited in claim 14, wherein said secondary controller is coupled to said pressure sensor and is configured to send an alarm signal when a pressure change occurs between said first and second sensors due to an increase or decrease in said measure airflow.

16. The HVAC system recited in claim 11, wherein said operational fan motor command is a rotational speed of said fan motor.

17. A computer program product, comprising a non-transitory computer usable medium having a computer readable program code embodied therein, said computer readable program code adapted to be executed to implement a method of measuring and managing an airflow rate of a heating, ventilating and air conditioning (HVAC) system, said method comprising:
relating an operational fan motor command of said HVAC system with an airflow rate of said HVAC system, such that a selected airflow rate will cause a fan motor of said HVAC system to operate based on said operational fan motor command to produce said selected airflow rate; and
building a calibration table during initial operation of an installed HVAC system, said calibration table relating a given operational fan motor command to a given airflow rate.

18. The computer program product of claim 17, wherein said method further comprises continuously measuring a present airflow rate and compare said measured airflow rate with a stored airflow rate in said calibration table.

19. The computer program product of claim 18, wherein said method further comprises sending an alarm signal when said present airflow rate is higher or lower than said stored airflow rate.

20. The computer program product of claim 19, wherein said method further comprises sending an alarm signal when a pressure change occurs between first and second pressure sensors located on opposite sides of an economizer of said HVAC system, said pressure change being due to an increase or decrease in said measure airflow.
